(19) United States
(12) Patent Application Publication
(10) Pub. No.: US 2015/0219945 A1
(43) Pub. Date: Aug. 6, 2015

(54) DISPLAY DRIVE APPARATUS AND DISPLAY DEVICE

(71) Applicant: Sharp Kabushiki Kaisha, Osaka (JP)

(72) Inventor: Kenichi Kimura, Osaka (JP)

(73) Assignee: Sharp Kabushiki Kaisha, Osaka (JP)

(21) Appl. No.: 14/420,852

(22) PCT Filed: Aug. 2, 2013
(86) PCT No.: PCT/JP2013/071012

§ 371 Date: Feb. 10, 2015

(30) Foreign Application Priority Data
Aug. 13, 2012 (JP) 2012-179564

(51) Int. Cl. G02F 1/133; G09G 3/36; G02F 1/1345

(52) U.S. Cl. CPC G02F 1/13306; G02F 1/13452; G09G 3/36; G09G 3/3674; G09G 3/3685; G09G 2320/0252

(57) ABSTRACT

A display drive apparatus (gate driver IC) in which the pitch of output line is narrower than a pixel pitch of a liquid crystal panel connected to the output line. The apparatus is provided with output circuits in which one end of each lead-out wiring is connected to a gate line or a signal line of the liquid-crystal panel having gate lines and signal lines in a matrix structure, and the other end of each of the lead-out wirings is connected to a driver output stage (gate driver). Adjustment circuits for correcting variations in line resistance corresponding to the array directions of the lead-out wirings are provided between the driver output stages and the lead-out wirings of the plurality of output circuits.

### TECHNICAL FIELD

The present invention relates to a display drive apparatus and a display device.

The present application claims priority to Japanese Patent Application No. 2012-179564, filed on Aug. 13, 2012, the disclosure of which is incorporated herein by reference in its entirety.

### BACKGROUND ART

In a liquid display device, a plurality of scanning lines (gate lines) and a plurality of signal lines (source lines) are arranged orthogonal to each other on a display panel, and pixel electrodes are arranged at vicinities of intersections of the gate lines and the source lines via thin-film transistors. A display pixel is formed by filling liquid crystal between the pixel electrodes and opposite electrode opposed individually to the pixel electrodes. Further, a display drive apparatus applies scanning signal voltages to the gate lines and gradation signal voltages to the source lines to perform display by changing the orientation state of the liquid crystal for each display pixel.

Here, the pitch of the output wiring of the display drive apparatus is smaller than the pixel pitch of the liquid crystal panel connected to the output wiring, and therefore, wirings connecting the output wirings of the display drive apparatus and the gate lines or the source lines are provided in a non-display region of the display panel. However, the wirings in this non-display region increase in wiring length as the wiring deviates from the center towards the outside in the array direction of the gate lines or the source lines, which increases the resistance value of the wiring viewed from a driver, which is an output structure of the display drive apparatus. For this reason, even if it is intended to apply the same voltage to each line from the driver of the display drive apparatus, the scanning signal voltage to be input to a display region in the case of the gate line, or the gradation signal voltage to be input to the display region in the case of the source line, becomes different every line, which causes deterioration of the display quality, e.g., occurrence of belt-like display unevenness, etc.

A liquid crystal display device is disclosed in, e.g., Patent Document 1, in which the length of the wiring with a low resistance value in the non-display region is increased to make the resistance value of the wiring in the non-display region approach a uniform value to improve the display quality.

### RELATED ART DOCUMENT

### Patent Document

Patent Document 1: Japanese Patent Application Laid-Open Publication No. 2004-70317

### SUMMARY OF THE INVENTION

### Problems to be Solved by the Invention

In the liquid crystal display device described in Patent Document 1, in order to make the wiring resistance values in the non-display region approach a uniform value by increasing the length of the wiring with a low resistance value in the non-display region, the wiring with a low resistance value at the intermediate part is formed into a bent shape. The bending is realized by forming the wiring into a curved shape, a rectangular wave shape (zigzag wiring shape), or the like (see FIG. 7 of Patent Document 1).

However, as the liquid crystal panel increases in size, the angle of the fan shape formed by the entire wirings in the non-display region increases. With this, the difference between the wiring length in the outer part of the non-display region and the wiring length in the intermediate part thereof further increases. To reduce the difference, a need for increasing the width of the non-display region to extend the zigzag wiring arises, which increases the area of the liquid crystal panel. Further, in order to realize high resolution of the image display, the number of the display pixels increases, and therefore, the number of the wirings increases. Regardless of that, if the zigzag wiring is employed, the wiring area per line increases, and therefore, this also makes it difficult to realize high-resolution of the image display. Further, since the wiring in the non-display region is formed in a complex shape with a bent shape, the electric field intensity between the wirings increases to readily cause a leak current (leakage current), and/or the breaking of wirings readily occurs.

The present invention was made in view of the aforementioned problems, and has a main object to suppress an increase of an area of a non-display region of a liquid crystal panel even in a case in which the liquid crystal panel is increased in size.

### Means for Solving the Problems

As a first configuration to solve the aforementioned problem, the display driver according to the present invention has a pitch of output wiring lines of the display driver is narrower than a pitch of pixels of a liquid crystal panel to which the display driver is configured to be connected, the display driver including: output circuits each including a driver output stage, each output circuit being configured to connect the driver output stage therein to one end of a lead-out wiring line that is connected, at another end thereof, to a gate wiring or a signal wiring forming a matrix structure of the liquid crystal panel, wherein a plurality of the output circuits respectively further include an adjustment circuit between the driver output stage and the lead-out wiring line for offsetting a variation in wiring resistance across an arrangement direction of the lead-out wiring lines.

Further, as a second configuration to solve the above-mentioned problems, a plurality of the adjustment circuits respectively include: a resistance circuit having a plurality of resistors in parallel, the resistance value of the plurality of resistors being set according to the variation in wiring resistance across the arrangement direction of the lead-out wiring lines; and a selection circuit that selects one of the plurality of resistors in the resistance circuit to electrically connect the driver output stage of a plurality of the output circuits to the lead-out wiring line.

Further, as a third configuration to solve the above-mentioned problems, an input of the selection circuit is kept unchanged, wherein the variation of the wiring resistances across the arrangement direction of the lead-out wiring lines is divided into a plurality of regions depending on a distance from a central driver output stage among the driver output stages of a plurality of the output circuits, and the resistance value of the resistance circuit is set in accordance with the divided region, and one resistor among the plurality of resistors of the resistance circuit is selected depending on the distance from the central driver output stage.

Further, as a fourth configuration to solve the above-mentioned problems, the display driver further includes: a controlling device that outputs selection signals to an input of the selection circuits; wherein the selection signal is input from the controlling device to the input of the selection circuit, and wherein two or more resistors among the plurality of resistors of the resistance circuit are selected depending on a distance from the central driver output stage.

Further, as a fifth configuration to solve the above-mentioned problems, in the output circuits that are located in a boundary region prescribed adjacent to a boundary between the respective divided regions, with respect to two resistors set respectively corresponding to the adjacent regions across the boundary among the divided regions, the resistor set for the divided region to which itself belongs and another resistor set for the adjacent divided region are alternately selected every one frame of display of the liquid display panel.

Further, as a sixth configuration to solve the above-mentioned problems, during a plurality of frames for display by the liquid crystal panel, in the output circuits that are located in a boundary region prescribed adjacent to a boundary between the respective divided regions, with respect to two resistors set respectively corresponding to the adjacent regions across the boundary among the divided regions, a ratio at which the resistor set for the divided region to which itself belongs is selected decreases and a ratio at which the other resistor set for the adjacent divided region is selected increases as the output circuits approaches the boundary.

Further, as the first configuration to solve the above-mentioned problems, a display device may include the liquid crystal panel and the display driver according to the first to sixth configurations mounted on the liquid crystal panel.

### Effects of the Invention

According the present invention, even if the resistance value of the wiring in a non-display region is different between an intermediate part and an outer peripheral part, it makes it possible to have the resistance value corresponding to a difference of wiring resistances to the adjustment circuit of the display drive apparatus. For this reason, even in cases where the liquid crystal panel is increased in size, resulting in an increased angle of the fan-shape of the wirings in the non-display region, which in turn further increases the wiring length difference between the wiring at the outer side and the wiring at the center side in the non-display region, it is not required to change the shape of the wirings in the non-display region to reduce the aforementioned difference. Therefore, it is not required to increase the width of the non-display region, and as a result, the increase in the area of the liquid crystal panel can be restrained. Further, even if the number of display pixels is increased to attain a high-definition image display and therefore the number of the wirings is increased, the display drive apparatus and the liquid crystal panel can be connected with straight wirings, which makes it easy to attain a high-definition screen display. Further, the wirings in the non-display region are not formed into complex shapes using bent forms, and thus, a leakage of current (leak current) between wirings and disconnection of the wiring are less likely to occur.

### BRIEF DESCRIPTION OF THE DRAWINGS

FIG. 1 is a block diagram showing an entire structure of a liquid crystal display device 1;

FIG. 2 is a cross-sectional view for explaining the entire structure of the liquid crystal display device 1;

FIG. 3 is a diagram showing an equivalent circuit of a single pixel provided in the liquid crystal panel;

FIG. 4 is a circuit diagram showing a principal structure of a gate driver IC 26;

FIG. 5 is a diagram showing a layout structure of wirings 106, wirings 107, and gate lines;

FIG. 6 is a diagram showing an inclination tendency of a wiring resistance of the wirings 107;

FIG. 7 is a diagram showing a corrected resistance value in which a correction resistance is added to the wiring resistance of the wiring 107 by an adjustment circuit 40;

FIG. 8 is a circuit diagram showing a principal structure of a gate driver IC26a;

FIG. 9 is a diagram showing a corrected resistance value in the case in which a correction resistance to be added to the wiring resistance of the wiring 107 is changed every frame;

FIG. 10 is a diagram showing corrected resistance values in the case in which a correction resistance to be added to the wiring resistance of the wiring 107 in a boundary region is changed every frame; and

FIG. 11 is a diagram showing a corrected resistance value in the case in which a selection ratio of a correction resistance to be added to the wiring resistance of the wiring 107 in a boundary region is changed.

### DETAILED DESCRIPTION EMBODIMENTS

Hereinafter, embodiments of the present invention will be described in detail with reference to the drawings.

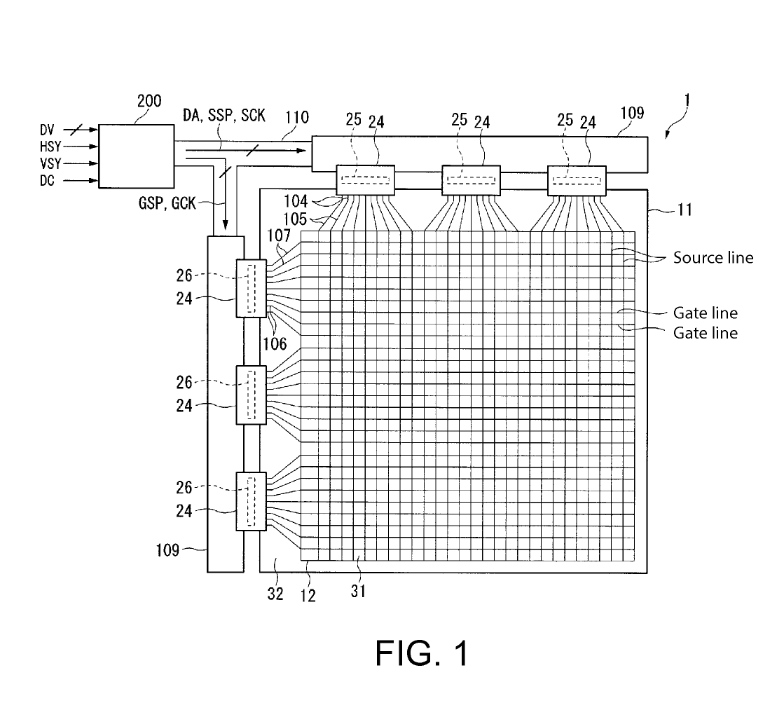

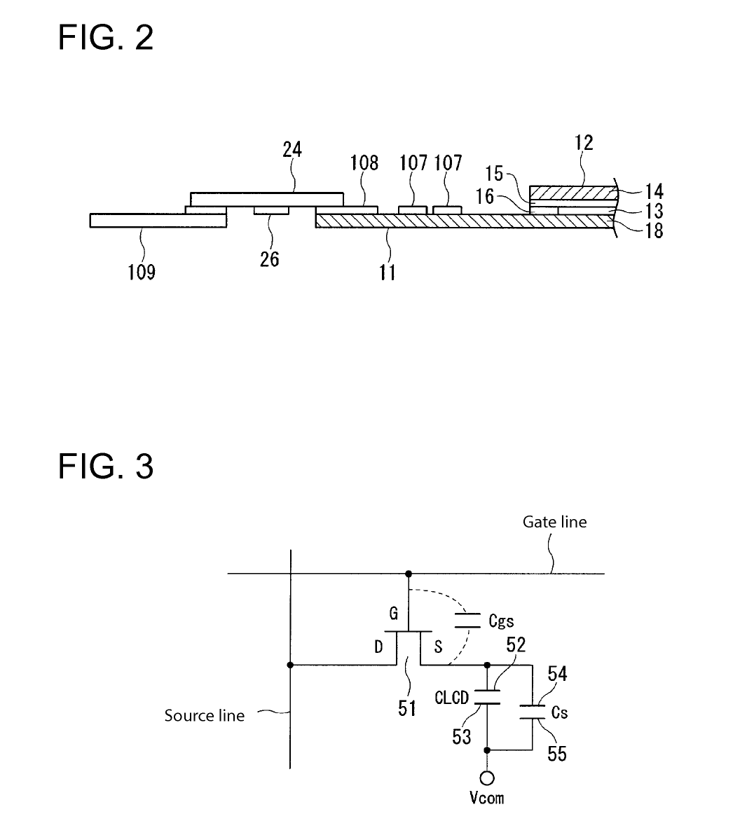

Initially, the entire structure of a liquid crystal display device 1 (display device) will be described with reference to FIGS. 1 and 2. FIG. 1 is a block diagram showing the entire structure of the liquid crystal display device 1. Further, FIG. 2 is a cross-sectional view for explaining the entire structure of the liquid crystal display device 1.

As shown in FIG. 1, the liquid crystal display device 1 includes a TFT (Thin-Film Transistor) substrate 11, an opposite substrate 12 arranged opposed to the TFT substrate 11, an SOF (System On Film) 24, a wiring substrate 109, a flexible substrate 110, and a control device 200.

As shown in FIG. 1, the liquid crystal display device 1 includes a display region 31 formed in a region where the TFT substrate 11 and the opposite substrate 12 face each other, and a frame-like non-display region 32 formed on the outer periphery of the display region. In the display region 31, a plurality of (matrix structure) pixels arranged in a matrix are formed.

On the opposite substrate 12, as shown in FIG. 2, a glass substrate 14 as a transparent insulated substrate, a color filter layer 15 formed on the liquid crystal layer 13 side, a common electrode (not illustrated in FIG. 2), and the like, are formed. Further, the liquid crystal layer 13 is sealed by a sealing member 16 provided between the TFT substrate 11 and the opposite substrate 12.

On the other hand, the TFT substrate 11 is formed on an active matrix substrate, and has a glass substrate 18 as a transparent insulated substrate. On the liquid crystal layer 13 side of the glass substrate 18, a plurality of source lines (signal wirings) extending in parallel each other, and a plurality of gate lines (gate wirings) extending perpendicular to the source lines are formed. The wiring group of the gate wirings and the source wirings is formed in a lattice shape as a whole. In the lattice region, pixels are formed (see FIG. 1). In each pixel, as it will be described later, a TFT (thin-film transistor) which is a switching element, and a pixel electrode connected thereto are formed. This TFT is connected to the aforementioned source line and gate line.

A liquid crystal panel is formed by the TFT substrate 11, the opposite substrate 12, and the liquid crystal layer 13 provided between the TFT substrate 11 and the opposite substrate 12.

Further, in the non-display region 32 of this TFT substrate 11, as shown in FIG. 1, a plurality of drivers SOF 24 as circuit members are mounted along the side section of the substrate. The driver SOF 24 is provided with a source driver IC 25 or a gate driver IC 26 (display drive apparatus).

The source driver IC 25 is a circuit for driving the source line in the display region 31. Further, the gate driver IC 26 is a circuit for driving the gate line in the display region 31 (the detailed operation will be described later).

Here, the pitch of the wiring 104, which is an output wiring of the source driver IC 25, is, as understood from FIG. 1, smaller than the pitch (pixel pitch in the gate line direction) of the source line of the liquid crystal panel connected to the output wiring. Therefore, the source line is connected to one end of the wiring 105 provided in the non-display region 32. Further, the other end of the wiring 105 is connected to the wiring 104. The plurality of wirings 105 provided corresponding to one source driver IC 25 are formed in a fan-shape in which the longitudinal direction (array direction) expands outwardly as seen from the center of the source driver IC 25.

In the same manner, the pitch of the wiring 106, which is an output wiring of the gate driver IC 26, is smaller than the pitch (pixel pitch in the source line direction) of the gate line of the liquid crystal panel connected to the output wiring. Therefore, the gate line is connected to one end of the wiring 107 provided in the non-display region 32. Further, the other end of the wiring 107 is connected to the wiring 106. The plurality of wirings 107 provided corresponding to one gate driver IC 26 are formed in a fan-shape in which the longitudinal direction (array direction) expands outwardly as seen from the center of the gate driver IC 26.

As described above, the plurality of drivers SOF 24 mounted on the side section of the TFT substrate 11 are connected to the source lines or the gate lines in the display region 31 by the fan-shaped wirings in the non-display region 32. Meanwhile, the outer side of each driver SOF 24 is connected to the wiring substrate (Printed Wiring Board) 109. The wiring substrates 109 are also connected by a flexible substrate 110 so that each driver SOF 24 can input a common control signal and so that signals can be transmitted/received between drivers SOF 24.

In the liquid crystal display device 1, the control device 200 (controller) is connected to the flexible substrate 110 to output a control signal to the source driver IC 25 and the gate driver IC 26. Before explaining the driving operation of the source driver IC 25 and the gate driver IC 26, the structure of the pixel will be described with reference to FIG. 3.

FIG. 3 is a diagram showing an equivalent circuit of a single pixel provided in the liquid crystal panel. As shown in FIG. 3, a gate electrode G of the thin-film transistor (TFT) 51 is connected to the gate line, and a drain electrode D of the TFT 51 is connected to the source line.

Further, in FIG. 3, the capacitance Cgs is denoted as a parasitic capacitance between the gate-source of TFT 51, the capacitance CLCD is denoted as a liquid crystal capacitance formed between the pixel electrode and the opposite electrode, and the capacitance Cs is denoted as an auxiliary capacitance for holding the gradation signal voltage input to the liquid crystal until the next display frame.

To the source electrode S of the TFT 51, one of the pixel electrodes 52 of the capacitance CLCD and one of electrodes 54 of the auxiliary capacitance Cs are connected. Further, the other opposite electrode 53 of the capacitance CLCD is arranged so as to face the pixel electrode 52, and the opposite electrode 53 is connected to a common signal line together with the other electrode 55 of the auxiliary capacitance Cs, so that a common signal voltage Vcom is input from the control device 200.

Returning to FIG. 1, the control device 200 receives a digital video signal Dv showing an image to be displayed, a horizontal synchronizing signal HSY and a vertical synchronizing signal VSY corresponding to the digital video signal Dv, and a control signal DC for controlling the mode, or the like of the display operation from an outside signal source, or the like. Based on these signals Dv, HSY, VSY, and DC, the control device 200 creates a starting pulse signal SSP for source drivers, a clock signal SCK for source drivers, and a digital image signal DA (signal corresponding to the video signal Dv) showing image to be displayed, as signals for displaying an image shown by the digital video signal DV in the display region 31. The control device 200 outputs these created signals to the source drivers IC 25. Further, based on these signals DV, HSY, VSY, and DC, the control device 200 creates a gate starting pulse signal GSP for gate drivers and a clock signal GCK for gate drivers. The control device 200 outputs these created signals to the gate drivers IC 26.

More specifically, the control device 200 outputs the video signal DV as a digital image signal DA from the control device 200 after performing a timing adjustment, or the like, in an internal memory as necessary, and creates a clock signal SCK for source drivers as a pulse signal corresponding to each pixel of an image shown by the digital image signal DA. Further, the control device 200 creates a starting pulse signal SSP for source drivers as a signal that becomes a high level (H level) only for a prescribed period every one horizontal scanning period in accordance with a horizontal synchronizing signal HSY. The control device 200 outputs these clock signal SCK for source drivers and starting pulse signal SSP for source drivers to the source drivers IC 25. Further, the control device 200 creates a gate starting pulse signal GSP for gate drivers as a signal that becomes a high level (H level) only for a prescribed period every one frame period (one vertical scanning period) in accordance with a vertical synchronizing signal VSY. Further, the control device 200 creates a gate clock signal GCK as a clock signal for gate drivers based on the horizontal synchronizing signal HSY. The control device 200 outputs these gate starting pulse signal GSP and gate clock signal GCK for gate drivers to the gate drivers IC 26.

The source driver IC 25 sequentially creates a gradation signal voltage every one horizontal scanning period as an analog voltage corresponding to the pixel value in each horizontal scanning line of an image shown by the digital image signal DA based on the digital image signal DA, the starting pulse signal SSP and clock signal SCK for source drivers. Further, the source driver IC 25 applies these gradation signal voltages to the respective data lines. The source driver IC 25 in this embodiment can employ a driving system, that is, a line inversion driving system, in which the gradation signal voltage is output so that the polarity of the applied voltage to the liquid crystal layer is inverted every one frame period and also inverted every one horizontal scanning line in each frame. Alternatively, from the viewpoint of improving the display quality, a driving system, that is, a dot inversion driving system in which the polarity of the applied voltage to the liquid crystal layer is inverted in one data line, can be employed. That is, the source driver IC 25 can be configured to output the gradation signal voltage so that the polarity of the applied voltage to each data line is inverted every data line. However, in place of this, it can be configured such that the source driver IC 25 outputs a gradation signal voltage so that the polarity of the applied voltage to each data line becomes the same polarity.

The gate driver IC 26 receives the gate starting pulse signal GSP and the clock signal GCK for gate drivers from the control device 200. The gate driver IC 26 sequentially selects each gate line in each frame period (each vertical scanning period) of the digital image signal DA based on these gate starting pulse single GSP and clock signal GCK for gate drivers, and applies an active gate signal (scanning signal voltage Vg to turn on the TFT 31) to the selected gate line.

By the aforementioned source drivers IC 25 and gate drivers IC 26, in the display region 31, the gradation signal voltages are applied to the respective data lines. Further, scanning signal voltages Vg are applied to the respective gate lines. With this, a gradation signal voltage corresponding to the value of the corresponding pixel in the image shown by the digital image signal DA is held in each pixel in the display region 31, and a voltage corresponding to the potential difference between the gradation signal voltage and the common signal voltage Vcom (hereinafter referred to as “voltage VLCD”) is applied to the liquid crystal layer 13 depending on the digital image signal DA. In other words, the voltage held by each pixel capacitance CLCD and CS becomes the applied voltage to the corresponding pixel liquid crystal. The display region 31 displays an image shown by the digital image signal DA, or an image shown by the digital video signal DV received from an outside signal source, or the like, by controlling light transmittance of the liquid crystal layer by the applied voltage.

### Embodiment 1

As explained above, when the vertical synchronizing signal VSY is input to the control device 200, the scanning signal voltage Vg is sequentially output from the gate driver IC 26, and therefore pixels become sequentially in a selected state from the upper line of the liquid crystal panel of the liquid crystal display device 1. Thus, gradation single voltages are input to the pixels that became a selected state. The voltage difference between the gradation signal voltage and the common signal voltage VCOM corresponds to the aforementioned voltage VLCD. Here, in the liquid crystal display device 1 having the structure shown in FIG. 1, in the non-display region 32, since there are differences in the wiring length among the wirings 107 connected to the gate lines, the wiring resistances of wirings including the wirings 106 corresponding to the output wirings of the source driver IC 25 differ from each other. Therefore, in the case in which scanning signal voltages Vg having the same magnitude (amplitude) are added to each gate line from the gate driver IC 26, the magnitudes of the scanning signal voltages Vg to be input to the gate lines differ because of the voltage drop amount differences due to the wiring resistance differences, and the magnitude of the scanning signal voltage Vg decreases as the wiring length of the wiring 107 increases.

Here, it is known that the magnitude of the gradation signal voltage to be applied to the liquid crystal drops by ΔV from the gradation signal voltage output from the source driver depending on the scanning signal voltage Vg. This ΔV is represented by the following equation (Formula 1) using the value of each capacitance in FIG. 3.

ΔV=(Cgs/Cs+CLCD+Cgs)×Vg (Formula 1)

Therefore, in (Formula 1), Vg differs every line (row), and therefore, for example, as the magnitude of the scanning signal voltage Vg decreases as the resistance value of the lead-out wiring (wiring 107) increases, ΔV increases. For this reason, even if the magnitude of the gradation signal voltage output from the source driver IC 25 is constant, the voltage VLCD actually applied to each display pixel does not become constant in one frame period. As a result, the display cannot be uniformity maintained, which may cause deterioration of the display quality, e.g., occurrence of belt-like display unevenness, or the like.

Therefore, in Embodiment 1, unlike the conventional manner in which a correction resistance is added to the wiring 107, resistors corresponding to correction resistances are provided in the gate driver IC 26, and one of the resistors is selected and connected to the wiring 106 and the wiring 107. With this, without increasing the width of the non-display region 32 (the distance in the direction of the gate line), by adjusting the scanning signal voltage Vg to be applied to the source line, the aforementioned ΔV is brought near to a constant value to thereby improve the display quality.

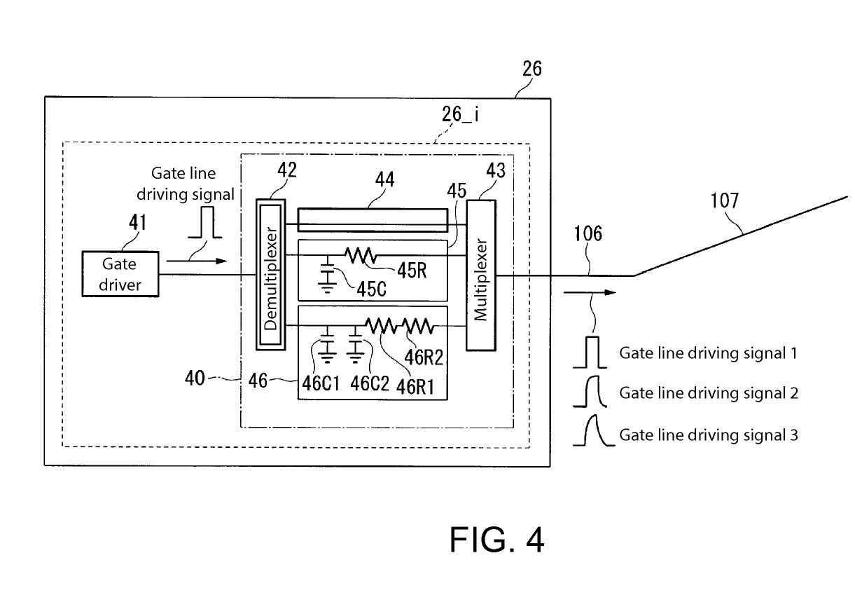

FIG. 4 is a circuit diagram showing a principal structure of the gate driver IC 26. Here, the circuit shown in FIG. 4 is provided in each line of the liquid crystal panel, and shows one of the output circuits 26_{—}i for driving one of gate lines. This output circuit 26_{—}i is provided with, as shown in FIG. 4, a gate driver 41 (driver output stage) and an adjustment circuit 40. The gate driver 41 is a circuit provided at the final stage of the gate driver IC 26, and is configured to output a square wave gate line driving signal to drive one gate line (to apply a scanning signal voltage Vg to one gate line).

The adjustment circuit 40 is provided with a demultiplexer 42, a multiplexer 43, and CR circuits 44 to 46 (resistance circuit).

The demultiplexer 42 is a demultiplexer having 1-input and 3-outputs and is configured to select one of the CR circuits 44 to 46 and output a gate line driving signal output from the gate driver 41 to the selected circuit. Further, the multiplexer 43 is a multiplexer having 3-inputs and 1-output, and is configured to select one of the CR circuits 44 to 46 and output the gate line driving signal output from the selected circuit to the wiring 106. In this embodiment, a selector (selector circuit) is constituted by the demultiplexer 42 and the multiplexer 43. The selector selects one of the CR circuits 44 to 46 and electrically connects the gate driver 41 and the wiring 106. In this embodiment, the selector switching control signal (selection signal) for switching the selector is fixed, and the circuit to be selected from the CR circuits 44 to 46 is set in advance for every output circuit 26_{—}i.

The CR circuit 44 is constituted only by a wiring directly connecting (directly coupling) the demultiplexer 42 and the multiplexer 43.

The CR circuit 45 is constituted by the resistor 45R and the capacitance 45C. The resistor 45R is inserted in the wiring directly connecting the demultiplexer 42 and multiplexer 43. The capacitance 45C is connected between the demultiplexer 42 side of the direct connection wiring and ground.

In the case in which the wiring length of the wiring 107 is medium (the angle between the longitudinal direction of the wiring 106 and the longitudinal direction of the wiring 107 is approximately a middle value between the maximum value and 0°), the capacitance 45C is set so that the potential variation at the inlet of the gate line to the liquid crystal panel becomes equal to the voltage variation at the inlet of the gate line to the liquid crystal panel in the case in which the wiring length of the wiring 107 is long (in the case in which the length direction of the wiring 106 and the length direction of the wiring 107 becomes maximum). For example, the difference between the wiring capacitance of the wiring 107 in the case in which the wiring length of the wiring 107 is medium and the wiring capacitance of the wiring 107 in the case in which the wiring length of the wiring 107 is long is set as the capacitance value.

Further, in the case in which the wiring length of the wiring 107 is medium, the resistor 45R is set so that the potential at the inlet of the gate line to the liquid crystal panel becomes equal to the potential at the inlet of the gate line to the liquid crystal panel in the case in which the wiring length of the wiring 107 is long. For example, the difference between the wiring resistance of the wiring 107 in which the wiring length of the wiring 107 is medium and the wiring resistance of the wiring 107 in which the wiring length of the wiring 107 is long is set to the resistance value. That is, as shown in FIG. 4, the CR circuit 45 rounds the waveform of the gate line driving signal output by the gate driver 41 and outputs the gate line driving signal 2.

Further, the CR circuit 46 is constituted by a resistor 46R1, a resistor 46R2, a capacitance 46C1, and a capacitance 46C2. The resistor 46R1 and the resistor 46R2 are inserted in the wiring directly connecting the demultiplexer 42 and multiplexer 43 in series. The capacitance 46C1 and the capacitance 46C2 are connected between the demultiplexer 42 side of the direct connection wiring and ground.

The capacitance 46C1 and 46C2 are set so that the potential variation at the inlet of the gate line to the liquid crystal panel in the case in which the wiring length of the wiring 107 is short (in the case in which the longitudinal direction of the wiring 106 and the longitudinal direction of the wiring 107 approximately coincide) becomes equal to the potential variation at the inlet of the gate line to the liquid crystal panel in the case in which the wiring length of the wiring 107 is long. For example, the difference between the wiring capacity of the wiring 107 in the case in which the wiring length of the wiring 107 is short and the wiring capacity of the wiring 107 in the case in which the wiring length of the wiring 107 is long is set as the capacitance value.

Further, the resistor 46R1 and the resistor 46R2 are set so that the potential at the inlet of the gate line to the liquid crystal panel in the case in which the wiring length of the wiring 107 is short becomes equal to the potential at the inlet of the gate line to the liquid crystal panel in the case in which the wiring length of the wiring 107 is long. For example, the difference between the wiring resistance of the wiring 107 in which the wiring length of the wiring 107 is short and the wiring resistance of the wiring 107 in which the wiring length of the wiring 107 is long is set as the resistance value. That is, as shown in FIG. 4, the CR circuit 46 rounds the waveform of the gate line driving signal output by the gate driver 41 and outputs the gate line driving signal 3.

The above explanation is directed to the case in which the adjustment circuit 40 among the output circuit 26_{—}i is embedded in the gate driver IC 26. However, it is enough that the adjustment circuit 40 be provided between the gate driver IC 26 and the wiring 106. For example, it can be configured such that the adjustment circuit 40 is mounted on the driver SOF 24 together with the gate driver IC 26.

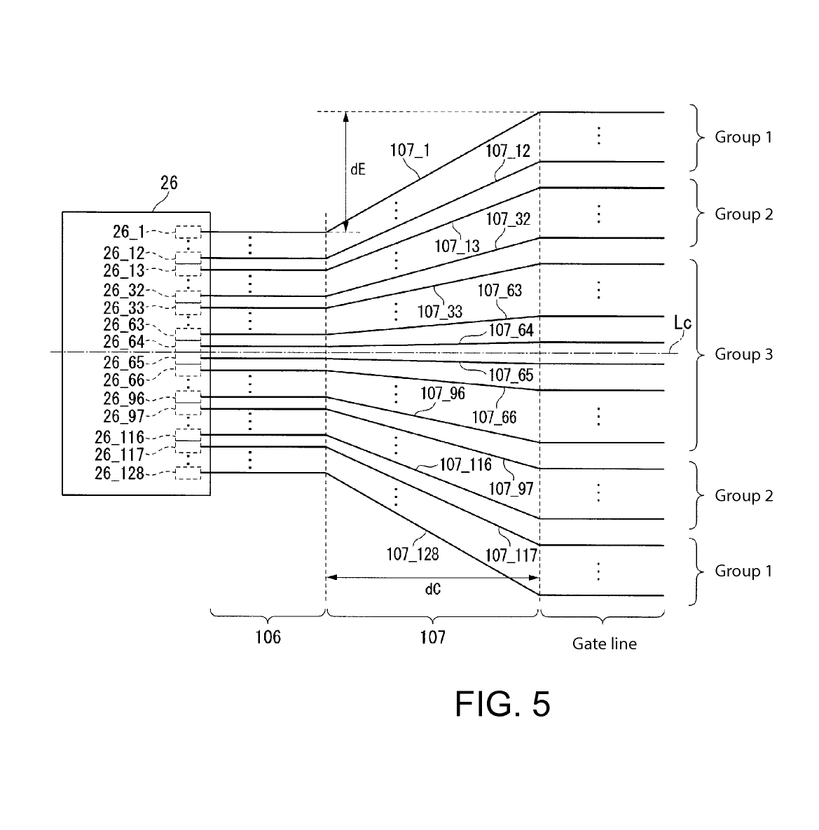

Initially, in the output circuit 26_{—}i (here, i is defined as 128 such that i=1 to 128), which CR circuit is selected among the CR circuits 44 to 46 will be described with reference to FIG. 5.

FIG. 5 is a diagram showing a layout structure of the wirings 106, the wirings 107, and the gate lines in the case in which the number of the output circuits 26_{—}i is 128. In FIG. 5, the gate driver IC 26 includes 128 pieces of output circuits 26_{—}i, or the output circuit 26_1 to the output circuit 26_128, arranged in a source line direction (in a direction perpendicular to the gate line direction).

FIG. 5 shows a case in which the pitch (a sum of the line width and the line spacing) of wirings 106, which are output wirings of the gate driver IC 26, is narrower than the pixel pitch (pitch of gate lines). The wirings connecting the wirings 106 and the gate lines are wirings 107. The center line Lc (shown by a dashed line in FIG. 5) shown in FIG. 5 is a straight line crossing the center of the gate driver IC 26 in the source line direction.

Further, the distance between the wiring 106 connected to the wiring 107 having the longest length and the gate line in the source line direction is shown by the distance dE, and the distance between the wiring 106 and the gate line in the gate line direction is shown by the distance dC. The distance dC is also a distance nearly equal to the wiring length of the wiring 107 positioned adjacent to the linear line Lc.

The plurality of wirings 107 (wiring 107_1 to wiring 107_128) become longer in wiring length as the wiring deviates from the center line Lc, and are divided into three Groups, i.e., a Group in which the wiring length is long, a Group in which the wiring length is intermediate, and a Group in which the wiring length is short. As a result of this division, the plurality of wirings 107, the plurality of wirings 106, and the output circuits 26_{—}i (i=1 to 128) connected to the wirings 107 via the wirings 106 are divided into Group 1, Group 2, and Group 3 as shown in FIG. 5.

When dividing into Group 1, Group 2, and Group 3, the number of wirings 107 in each Group is: 24 pieces, which is about 20% of the entirety (128), in Group 1; 40 pieces, which is about 30% of the entirety, in Group 2, and 64 pieces, which is 50% of the entirety, in Group 3.

The ratio of the number of wirings 107 in each Group to the entire number of wirings 107 is not limited to the above value. Further, the number of dividing Groups, and the ratio of the number of wirings 107 in each Group to the entire number of wirings are set to predetermined values depending on the number of wirings 106, which are output wirings of the gate drivers IC 26, and each resistance value of the wiring 107.

Further, corresponding to each Group, the output circuits 26_{—}i are connected to the wirings 107 via the wirings 106 as follows.

In Group 1, the output circuits 26_1 to 26_12 and 26_117 to 26_128 are connected to the corresponding wirings 107_1 to 107_12 and 107_117 to 107_128 via the wirings 106, which are output wirings, respectively.

Further, in Group 2, the output circuits 26_13 to 26_32, and the output circuits 26_97 to 26_116 are connected to the corresponding wirings 107_13 to 107_32 and 107_97 to 107_116 via the wirings 106, which are output wirings, respectively.

Further, in Group 3, the output circuits 26_33 to 26_96 are connected to the corresponding wirings 107_33 to 107_96 via the wirings 106, respectively.

In Group 1, in the output circuits 26_1 to 26_12 and 26_117 to 26_128, corresponding to each wiring 107, the selector switching control signal (selection signal) of the selector (demultiplexer 42 and multiplexer 43) is fixed so that the CR circuit 44 in the adjustment circuit 40 is fixedly selected.

Further, in Group 2, in the output circuits 26_13 to 26_32, 26_97 to 26_116, corresponding to the wirings 107 of Group 2, the selector switching control signal of the selector is fixed so that the CR circuit 45 in the adjustment circuit 40 is fixedly selected.

Further, in Group 3, in the output circuits 26_33 to 26_96, corresponding to the wirings 107 of Group 3, the selector switching control signal of the selector is fixed so that the CR circuit 46 in the adjustment circuit 40 is fixedly selected.

Next, how to set the resistance values of the resistor 45R, the resistor 46R1, and the resistor 46R2 will be described.

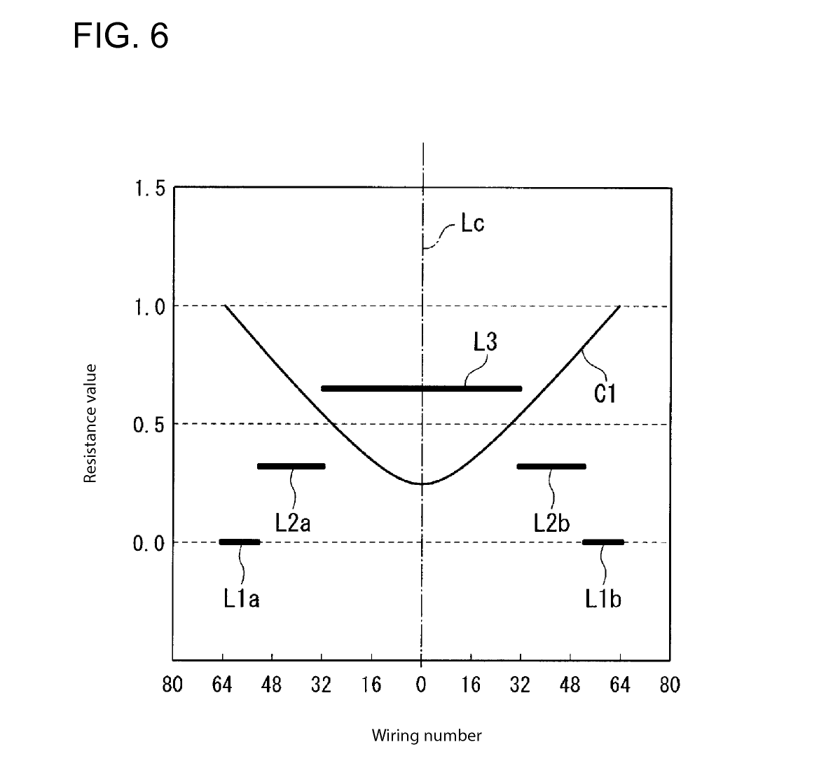

FIG. 6 is a diagram showing an inclination tendency of wiring resistances of the wirings 107. In FIG. 6, the vertical axis shows the resistance value, and the horizontal axis shows the wiring number. The wiring number shows what number the wiring 107_{—}i is when counting from the center line Lc. That is, the left side wiring numbers 64 to 1 when the center line Lc is 0 correspond to the wirings 107_1 to 107_64, and the right side wiring numbers 1 to 64 on the right side of the center line Lc correspond to the wirings 107_65 to 107_128.

In FIG. 6, corresponding to these wiring numbers, the resistance value of the wiring 107_{—}i shown in FIG. 5 and the resistance value to be set to the output circuit 26_{—}i are plotted.

The resistance value of the wiring 107_{—}i (i=1 to 128) shows a resistance value, assuming that the distance dE in FIG. 5 is 4 times longer than the distance dC and that the resistance value of the longest wiring 107_1 (or wiring 107_128) is 1.

In FIG. 6, the curve C1 shows the resistance value of the wiring 107_{—}i. That is, the curve C1 shows the inclination tendency of wiring resistances of the wirings 107 (variation of wiring resistances corresponding to the array direction of the wirings 107).

Further, in FIG. 6, the straight line L1, the straight line L2a, the straight line L2b, the straight line L3a, and the straight line L3b show the following resistance values.

The straight line L1a and the straight line L1b show that the correction resistance value to be set to the CR circuit 44 in the adjustment circuit 40 of the output circuit 26_{—}i is 0Ω. That is, in the adjustment circuit 40 of the output circuits 26_1 to 26_12, and the output circuits 26_117 to 26_128 provided corresponding to the wirings 107_1 to 107_12, and the wirings 107_117 to 107_128 (the wiring number 53 to the wiring number 64 shown in FIG. 6), which belong to the wirings of Group 1, the CR circuit 44 is always selected.

Further, the straight line L2a and the straight line L2b show correction resistance values to be set to the CR circuit 45 in the adjustment circuit 40 of the output circuit 26_{—}i. This correction resistance value is preliminarily obtained from the difference between the representative value of the resistance of the wirings 107 of Group 2 and the correction resistance value0Ω of Group 1.

Here, as the representative value, the average value of the wirings 107 of Group 2 is used, but other representative values such as the minimum value of Group 2 (the resistance value of the wiring 107_32 or the wiring 107_97) can be used. This correction resistance value is a resistance value of the resistor 45R of the CR circuit 45 in the adjustment circuit 40 of the output circuit 26_{—}i. The average value of the wiring capacitance of the wirings 107 of Group 2 is set to the capacitance 45C of the CR circuit 45.

That is, in the adjustment circuit 40 of the output circuits 26_13 to 26_32 and the output circuits 26_97 to 26_116 provided corresponding to the wirings 107_13 to 107_32 and the wirings 107_97 to 107_116 (wiring number 33 to wiring number 52 shown in FIG. 6), which belong to the wirings of Group 2, the CR circuit 45 is always selected.

Further, the straight line L3 shows a correction resistance value to be set to the CR circuit 46 in the adjustment circuit 40 of the output circuit 26_{—}i. This correction resistance value is preliminarily obtained from the difference between a representative value of the wiring resistances of the wirings 107 of Group 3 and the correction resistance value 0Ω of Group 1. Here, as the representative value, the average value of the wirings 107 of Group 3 is used, but other representative values such as the minimum value of Group 3 (the resistance value of the wiring 107_64 or the wiring 107_65), or the like can be used. This correction resistance value is a combined resistance value (series resistance value) of the resistor 46R1 and the resistor 46R2 of the CR circuit 46 in the adjustment circuit 40 of the output circuit 26_{—}i. The average value of the wiring capacitance of the wirings 107 of Group 3 is set as the capacitance 46C1 and the capacitance 46C2 of the CR circuit 46. In the adjustment circuit 40 of the output circuits 26_33 to the output circuits 26_96 provided corresponding to the wirings 107_33 to 107_96 (wiring number 1 to wiring number 32 shown in FIG. 6), which belong to the wirings of Group 3, the CR circuit 46 is always selected.

A resistance value after correction when a correction resistance in each group as mentioned above is set to the CR circuit of the adjustment circuit 40 and the correction resistance is added to the wiring resistance of the wiring 107 by the CR circuit will be described with reference to the drawing.

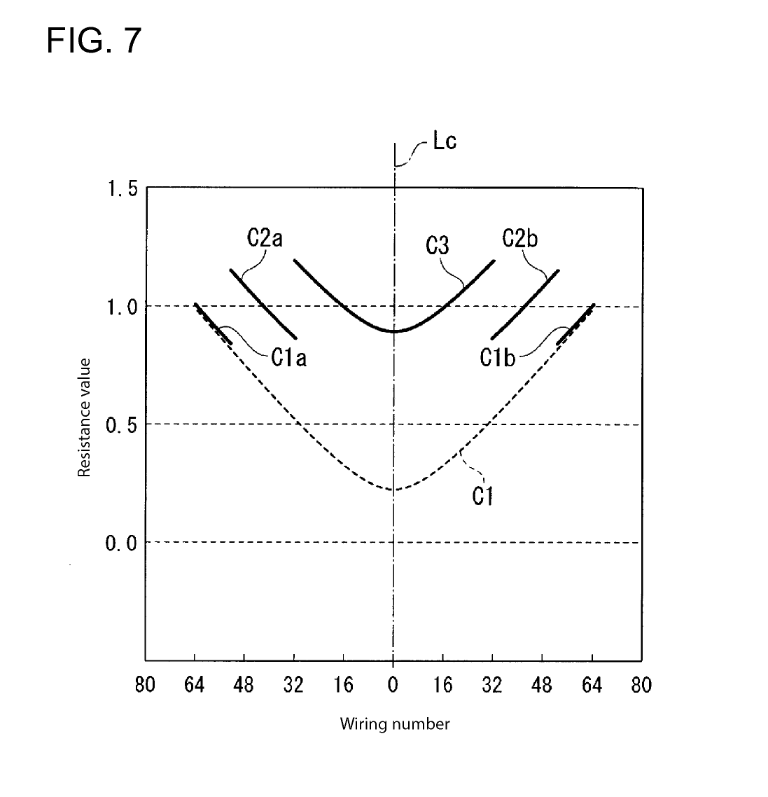

FIG. 7 is a diagram showing resistance values after corrections in which a correction resistance is added to the wiring resistance of the wiring 107 by the adjustment circuit 40. In FIG. 7, the curve line C1 shown in FIG. 6 is also shown. In FIG. 7, the curve line C1a, the curve line C1b, the curve line C2a, the curve line C2b, and the curve line C3 show the following resistance value.

The curve line C1a and the curve line C1b show that 0Ω as a correction resistance value is added to the resistance value of each of the wirings 107_1 to 107_12 and the wirings 107_117 to 107_128 (the wiring numbers 53 to 64 shown in FIG. 6), which are wirings of Group 1. That is, the resistance value after correction shown by the curve line C1a and the curve line C1b is the same as the resistance value shown by the curve line C1.

Further, the curve line C2a and the curve line C2b show values in which the resistance value of the resistor 45R set to the CR circuit 45 as a correction value is added to the resistance value of each of the wirings 107_13 to 107_32 and the wirings 107_97 to 107_116 (the wiring numbers 33 to 52 shown in FIG. 6), which are wirings of Group 2.

Further, the curve line C3 shows values (resistance values after corrections) in which a combined resistance value of the resistance value of the resistor 46R1 and the resistor 46R2 set to the CR circuit 46 as a correction value is added to the resistance value of each of the wirings 107_33 to 107_96, which are wirings of Group 3.

The 128 resistance values shown by the curve line C1 and the 128 resistance values after correction shown by the curve line C1a, the curve line C1b, the curve line C2a, the curve line C2b, and the curve line C3 were compared.

That is, in regards to the respective 128 resistance values, an average AVG, the minimum value MIN, the maximum value MAX, the difference between the maximum value and the minimum value (MAX−MIN), and variance σ² (a value obtained by dividing a sum of squares of the difference between the resistance value of each point and the average ACG by the number of points 128) were obtained, and compared. The comparison results are as follows:

The average ACG, the minimum value MIN, the maximum value MAX, the difference (MAX−MIN), and the variance σ² of the 128 resistance values shown by the curve line C1 were 0.567, 0.243, 1, 0.757, and 0.0561. On the other hand, the average ACG, the minimum value MIN, the maximum value MAX, the difference (MAX−MIN), and the variance σ² of the 128 resistance values after correction shown by the curve line C1a, the curve line C1b, the curve line C2a, the curve line C2b, and the curve line C3 were 0.986, 0.839, 1.175, 0.336, and 0.0079.

The above shows that the values of the difference (MAX-MIN) and the variance σ² were decreased by adding the correction resistance to the wiring 107 by providing the adjustment circuit 40. Thus, by providing the adjustment circuit 40 to add the correction resistance to the wiring 107, the difference among the wiring resistances of the wirings 107 between the output circuit 26_{—}i and the gate line can be reduced. Further, by being able to reduce the difference in wiring resistance, the potential difference of the scanning signal voltage Vg at the inlet (connecting point of the wiring 107) of the gate line every gate line can be eliminated, which in turn can improve the display quality of the liquid crystal display device 1.

Further, even in cases where the liquid crystal panel is increased in size, resulting in an increased angle (the angle between the longitudinal direction of the wiring 107_1 and the longitudinal direction of the wiring 106) of the fan-shape of the wirings in the non-display region 32, which in turn further increases the wiring length difference between the wiring 107 at the outer side and the wiring 107 at the center side in the non-display region 32, it is not required to change the shape of the wirings 107 in the non-display region 32 as in a conventional manner to reduce the aforementioned difference.

Therefore, it is not required to increase the width of the non-display region 32, and as a result, the increase in the area of the liquid crystal panel can be suppressed. Further, even if the number of display pixels is increased to attain a high-definition image display and therefore the wiring number of the wirings 107 is increased, the gate driver IC 26 (display drive apparatus) and the liquid crystal panel can be connected with straight wirings (wirings 107), which makes it easy to attain a high-definition screen display. Further, the wirings 107 in the non-display region 32 are not formed into complex shapes using bent forms, and thus, a leakage of current (leak current) between wirings (between the wiring 107 and the wiring 107) and disconnection of the wiring are less likely to occur.

### Embodiment 2

The aforementioned technical concept described in Embodiment 1 can also be applied to the source drivers IC 25 shown in FIG. 1. As to the wirings 105 (lead-out wiring) connecting the wirings 104, which is an output wiring of the source driver IC, and the source lines as shown in FIG. 1, all of the contents described with reference to FIGS. 5 to 7 can be applied.

Therefore, with respect to the source driver IC 25, in the same manner as the gate driver IC 26 shown in FIG. 4, groups of the wirings 105 are configured based on the inclination tendency (from the curve line C1 shown in FIG. 6) of the wiring resistances of the wirings 105, and a correction resistance corresponding to each group is set to the CR circuit of the adjustment circuit.

With this, the difference of the wiring resistances of the wirings 104 between the output circuit of the source driver IC and the gate line can be reduced. Since the wiring resistance can be reduced, the potential difference of the gradation signal voltage at the inlet (connecting point of the wiring 105) of the source line every source line can be eliminated (see Formula (1) in paragraph [0027]), which in turn can improve the display quality of the liquid crystal display device 1.

Further, in the same manner as in Embodiment 1, even in cases where the angle (the angel between the longitudinal direction of the outside wiring 105 and the longitudinal direction of the wiring 104) of the fan-shape of the entire wirings in the non-display region 32 is increased, and therefore, the wiring length difference between the wiring 105 at the outer side and the wiring 105 at the center side in the non-display region 32, it is not required to change the shape of the wirings 105 in the non-display region 32 as in a conventional manner to reduce the aforementioned difference.

Therefore, it is not required to increase the width of the non-display region 32, and as a result, the increase in the area of the liquid crystal panel can be suppressed. Further, even if the number of display pixels is increased to attain a high-definition image display and therefore, the number of the wirings 105 is increased, the source driver IC 25 (display drive apparatus) and the liquid crystal panel can be connected with straight wirings (wirings 105), which makes it easy to attain a high-definition screen display. Further, the wirings 105 in the non-display region 32 are not formed into complex shapes using bent forms, and thus, a leakage of current (leak current) between wirings (between the wiring 105 and the wiring 105) and disconnection of the wiring are less likely to occur.

### Embodiment 3

In Embodiment 1, since the switching control signal for controlling the switching of the selectors (demultiplexer 42 and the multiplexer 43) is fixed, it is always decided which preliminarily set correction resistance will be used to which region of the liquid crystal panel. That is, to each gate line of the liquid crystal panel, any one of adjusted gate line driving signals (gate line driving signals 1 to 3 as shown in FIG. 4) in which a correction resistance is connected to the gate line driving signal is applied further through the wiring 106 and the wiring 107. In this case, which gate line driving signal will be used for which gate line of the liquid crystal panel is fixed. However, in Embodiment 3, the driving of the source line is performed more finely without this fixing.

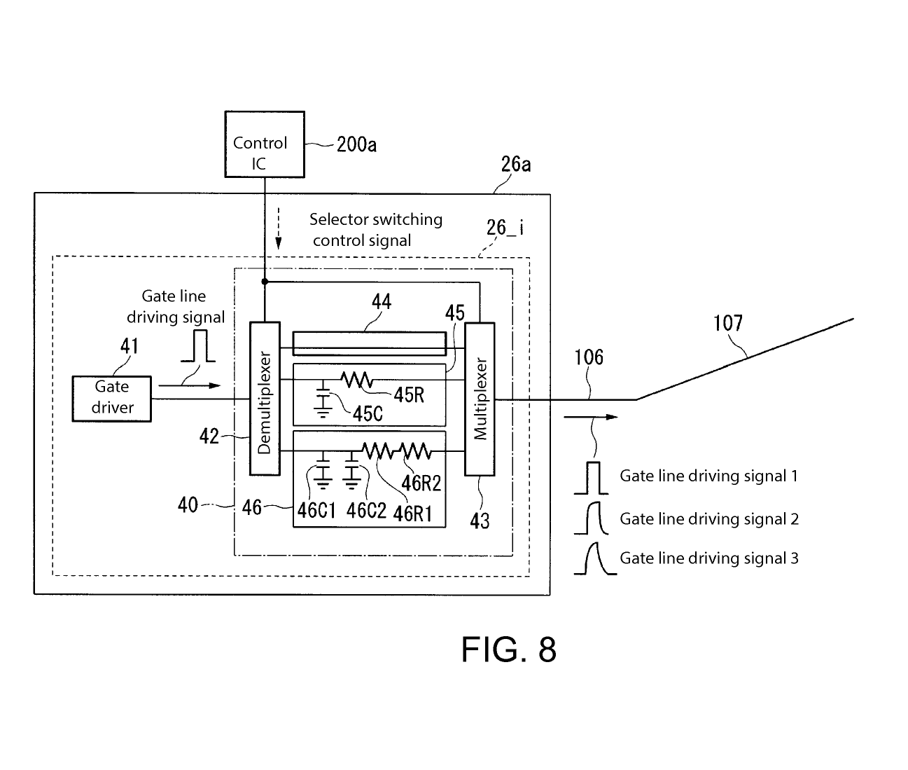

FIG. 8 is a circuit diagram showing a principal structure of the gate driver IC 26a. In FIG. 8, the same symbol is allotted to the same portion in FIG. 7 and the explanation will be omitted.

As shown in FIG. 8, in the gate driver IC 26a, a selector switching control signal (selection signal) for switching the demultiplexer 42 and the multiplexer 43 (selector) is input from an outer controlling IC 200a (controller). This controlling IC 200a outputs a selector switching control signal every one frame, and therefore, it can be the aforementioned control device 200 shown in FIG. 1. Accordingly, a selector switching control signal is input to the selector every one frame, so that any one of CR circuits among the CR circuits 44 to 46 can be selected every one frame.

For example, in Embodiment 1, the wirings 107 of Group 1 were connected to the CR circuit 44, the wirings 107 of Group 2 were connected to the CR circuit 45, and the wirings 107 of Group 3 were connected to the CR circuit 44 by the selector of the adjustment circuit 40 in a fixed manner.

On the other hand, it becomes possible to connect the wirings 107 of Group 2 to the CR circuit 44 and the circuit 45 alternately every one frame and connect the wirings 107 of Group 3 to the CR circuit 45 and the CR circuit 46 alternately every one frame, with the wirings 107 of Group 1 connected to the CR circuit 44.

By doing so, since an intermediate waveform of the gate line driving signal 1 and the gate line driving signal 2 is applied to each of the wirings 107 of Group 2, it is not required to separately provide a CR circuit having an intermediate value of the resistance (resistance value 0Ω) and the capacitance (capacitance value 0) of the CR circuit 44 and the resistance and the capacitance of the CR circuit 45. Further, since an intermediate waveform of the gate line driving signal 2 and the gate line driving signal 3 is applied to each of the wirings 107 of Group 3, it is not required to separately provide a CR circuit having an intermediate value of the resistance and the capacitance of the CR circuit 45 and the resistance and the capacitance of the CR circuit 46.

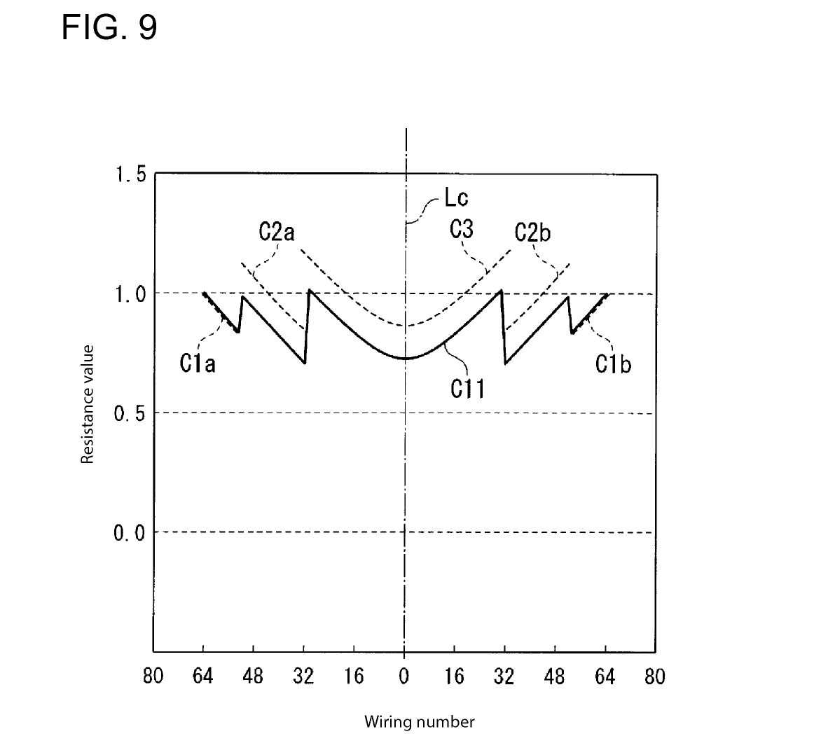

FIG. 9 is a diagram showing a resistance value after correction in the case in which a correction resistance to be added to the wiring resistance of the wiring 107 every frame is changed every frame. In FIG. 9, the curve line C1a, the curve line C1b, the curve line C2a, the curve line C2b, and the curve line C3 shown in FIG. 7 are also shown.

In FIG. 9, the curve line C11 shows resistance values of the wirings 107_{—}i after correction in the case in which a correction resistance to be added to the wiring resistance of the wiring 107 is changed every frame. That is, the curve line C11 shows an inclination tendency (variation of wiring resistance corresponding to the array direction of the wirings 107) of the wirings 107 in the case in which a correction resistance to be added to the wiring resistance of the wiring 107 is changed every frame.

The curve line C11 shows that the corrected resistance values of the wirings 107_1 to 107_12 and the wirings 107_117 to 107_128 (the wiring numbers 53 to 64 shown in FIG. 9), which are wirings of Group 1, are the same as the corrected resistance values shown by the curve line C1a and the curve line C1b. That is, this shows that 0Ω as the correction resistance value is added to these wirings 107 of Group 1.

Further, the curve line C11 shows that a correction resistance lower than the curve line C2a and the curve line C2b is added to the wirings 107_13 to 107_32 and the wirings 107_97 to 107_116 (the wiring numbers 33 to 52 shown in FIG. 9), which are wirings of Group 2. That is, it shows that an intermediate value between the resistance value of the resistor 45R set to the CR circuit 45 and 0Ω is added to the wirings 107_13 to 107_32 and the wirings 107_97 to 107_116, which are wirings of Group 2.

Further, the curve line C11 shows that a correction resistance lower than the curve line C2a and the curve C2b is added to the wirings 107_33 to 107_96 (the wiring numbers 1 to 32 shown in FIG. 9), which are wirings of Group 3. That is, it shows that an intermediate value of the combined resistance value of the resistor 46R1 and the resistor 46R2 set to the CR circuit 46 and the resistance value of the resistor 45R set to the CR circuit 45 as a correction value added to the wirings 107_33 to 107_96, which are wirings of Group 3.

One hundred twenty-eight (128) corrected resistance values shown by the curve line C1a, the curve line C1b, the curve line C2a, the curve line C2b and the curve line C3, and one hundred twenty-eight (128) resistance values shown by the curve line C11 are compared.

That is, with respect to each of 128 resistance values, in the same manner as in Embodiment 1, the average AVG, the minimum value MIN, the maximum value MAX, the difference (MAX-MIN), and the variance σ² were obtained, and compared. The comparison results are as follows.

As explained in Embodiment 1, the average ACG, the minimum value MIN, the maximum value MAX, the difference (MAX−MIN), and the variance σ² of the 128 corrected resistance values shown by the curve line C1a, the curve line C1b, the curve line C2a, the curve line C2b, and the curve line C3 were 0.986, 0.839, 1.175, 0.336, and 0.0079. On the other hand, the average ACG, the minimum value MIN, the maximum value MAX, the difference (MAX−MIN), and the variance σ² of the 128 resistance values shown by the curve C11 were 0.854, 0.701, 1.011, 0.309, and 0.0078.

It is understood that the difference (MAX−MIN) is decreased by providing the adjustment circuit 40 to alternately add a correction resistance to the wirings 107 every one frame although the value of variance σ² remains unchanged. From this reason, by providing the adjustment circuit 40 to add a correction resistance to the wirings 107 every one frame, in the same manner as in Embodiment 1, the difference of the wiring resistance among the wirings 107 between the output circuit 26_{—}i and the gate line can be reduced. Further, since the wiring resistance difference can be reduced, the potential difference of the scanning signal voltage Vg at the inlet (connecting point of the wiring 107) of the gate line every gate line can be eliminated, which in turn can improve the display quality of the liquid crystal display device 1.

As explained, a controlling apparatus (controlling IC 200a) that outputs a selection signal in response to an input of the selection circuit (demultiplexer 42 and multiplexer 43) is provided, and the selection signal is input to the input of the selection circuit from the controlling IC 200a, and two or more resistances among the plurality of resistances of the resistance circuits (CR circuit 44 to CR circuit 46) are selected depending on the distance from the central driver output stage. In the above example, for example, in the output circuits 26_33 to 26_96 to be connected to the wirings 107_33 to 107_96 of Group 3, respectively, the CR circuit 45 and the CR circuit 46 are selected, so that the resistance (correction resistance) to be added to the resistance of the wiring 107 is switched.

Thus, in Embodiment 3, the case in which the switching is preformed every one frame utilizing such switching of the correction resistance about the boundary region of Group 1 and Group 2 and the boundary region of Group 2 and Group 3 will be described.

Here, the boundary region denotes a region preliminarily set to a predetermined number of wirings 107 arranged inside from each Group switching portion (boundary), and the output circuits 26_{—}i connected to these wirings 107 via the wirings 106. In this boundary region, in the CR circuit of the output circuit 26_{—}i, the CR circuit used by the Group that the CR circuit itself belongs and the CR circuit used by the adjacent Group (opposite across the boundary) are switched by the controlling IC 200a every one frame.

For example, the boundary region will be described in reference to FIG. 5. Five wirings 107_8 to 107_12 close to Group 2 among the wirings 107 of Group 1 and four wirings 107_13 to 107_16 close to Group 1 among the wirings 107 of Group 2 denote a boundary region B1.

Further, five wirings 107_28 to 107_32 close to Group 3 among the wirings 107 of Group 2 and four wirings 107_33 to 107_36 close to Group 2 among the wirings 107 of Group 3 denote a boundary region A1.

Further, five wirings 107_92 to 107_96 close to Group 2 among the wirings 107 of Group 3 and four wirings 107_97 to 107_100 close to Group 3 among the wirings 107 of Group 2 denote a boundary region A2.

Further, four wirings 107_113 to 107_116 close to Group 1 among the wirings 107 of Group 2 and five wirings 107_117 to 107_121 close to Group 2 among the wirings 107 of Group 1 denote a boundary region B2.

Thus, in FIG. 5, from the upper side of the drawing to the lower side thereof, i.e., from the output circuit 26_1 to the output circuit 26_128, the boundary region B1 is set between Group 1 and Group 2, the boundary region A1 is set between Group 2 and Group 3, the boundary region A2 is set between Group 3 and Group 2, and the boundary region B2 is set between Group 2 and Group 1.

The number of wirings 107 included in each of two Groups belonging to each boundary region is not limited to the aforementioned example, and can be arbitrarily set by the selector switching control signal (selection signal) that the controlling IC 200a outputs.

In the adjustment circuit 40 of each of the output circuits 26_8 to 26_12 connected to the wirings 107_8 to 107_12 of the wirings 107 of Group 1 among the wirings 107 in the boundary region B1, the CR circuit 44 and the CR circuit 45 are alternately selected every one frame.

Further, in the adjustment circuit 40 of each of the output circuits 26_13 to 26_16 connected to the wirings 107_13 to 107_16 of Group 2 among the wirings 107 in the boundary region B1, the CR circuit 45 and the CR circuit 44 are alternately selected every one frame.

Further, in the adjustment circuit 40 of the output circuits 26_28 to 26_32 connected to each of the wirings 107_28 to 107_32 of Group 2 among the wirings 107 in the boundary region A1, the CR circuit 45 and the CR circuit 46 are alternately selected every one frame.

Further, in the adjustment circuit 40 of the output circuits 26_33 to 26_36 connected to each of the wirings 107_33 to 107_36 of Group 3 among the wirings 107 in the boundary region A1, the CR circuit 46 and the CR circuit 45 are alternately selected every one frame.

Further, in the adjustment circuit 40 of the output circuits 26_92 to 26_96 connected to each of the wirings 107_92 to 107_96 of Group 3 among the wirings 107 in the boundary region A2, the CR circuit 46 and the CR circuit 45 are alternately selected every one frame.

Further, in the adjustment circuit 40 of the output circuits 26_97 to 26_100 connected to each of the wirings 107_97 to 107_100 of Group 2 among the wirings 107 in the boundary region A2, the CR circuit 45 and the CR circuit 46 are alternately selected every one frame.

In the adjustment circuit 40 of the output circuits 26_113 to 26_116 connected to each of the wirings 107_113 to 107_116 of Group 2 among the wirings 107 in the boundary region B2, the CR circuit 45 and the CR circuit 44 are alternately selected every one frame.

Further, in the adjustment circuit 40 of the output circuits 26_117 to 26_121 connected to the wirings 107_117 to 107_121 of Group 1 among the wirings 107 in the boundary region B2, the CR circuit 44 and the CR circuit 45 are alternately selected every one frame.

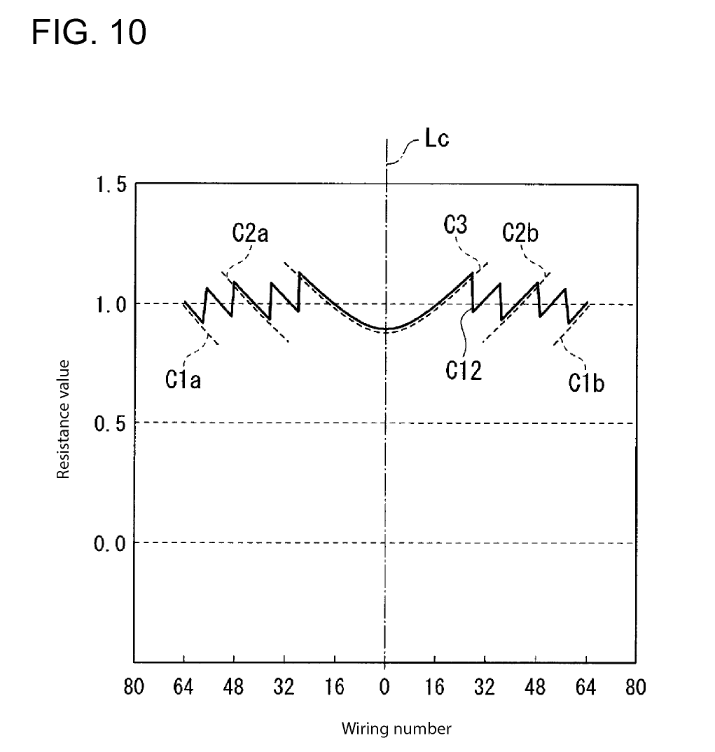

FIG. 10 is a diagram showing corrected resistance values in the case in which a correction resistance to be added to the wiring resistance of the wiring 107 in a boundary region is changed every frame. In FIG. 10, the curve line C1a, the curve line C1b, the curve line C2a, the curve line C2b, and the curve line C3 shown in FIG. 7 are also shown.

In FIG. 10, the curve line C12 shows corrected pseudo-resistance values of the wiring 107_{—}i in the case in which a correction resistance to be added to the wiring resistance of the wiring 107 in a boundary region is changed every frame. The “pseudo” means that a liquid crystal panel essentially shows a display as if the gate line to which the resistance value shown in FIG. 10 is added is driven when a plurality of frames are collectively seen by switching every one frame. That is, the curve line C12 shows a pseudo-inclination tendency (variation of wiring resistance corresponding to the array direction of the wirings 107) of the wirings 107 in the case in which a correction resistance to be added to the wiring resistance of the wiring 107 is changed every frame.

The curve line C12 shows that a correction resistance higher than that of the curve line C1a is added to the wirings 107_8 to 107_12 of Group 1 (wiring numbers 53 to 57 shown in FIG. 10) in the boundary region B1 (wirings numbers 49 to 57 shown in FIG. 10). That is, the curve line C12 shows that an intermediate value of 0Ω and the resistance value of the resistor 45R set to the CR circuit 45 is added as a correction value to the wirings 107_8 to 107_12 of Group 1 in the boundary region B1.

Further, the curve line C12 shows that a correction resistance lower than that of the curve line C2a is added to the wirings 107_13 to 107_16 of Group 2 (wiring numbers 49 to 52 shown in FIG. 10) in the boundary region B1 (wirings numbers 49 to 52 shown in FIG. 10). That is, the curve line C12 shows that an intermediate value of the resistance value of the resistor 45R set to the CR circuit 45 and 0Ω is added to the wirings 107_13 to 107_16 of Group 2 as a correction value in the boundary region B1.

The curve line C12 shows that a correction resistance higher than that of the curve line C2a is added to the wirings 107_28 to 107_32 of Group 2 (wiring numbers 33 to 37 shown in FIG. 10) in the boundary region A1 (wirings numbers 29 to 37 shown in FIG. 10).

That is, the curve line C12 shows that an intermediate value of the resistance value of the resistor 45R set to the CR circuit 45 and the combined resistance value of the resistor 46R1 and the resistor 46R2 set to the CR circuit 46 is added to the wirings 107_28 to 107_32 of Group 2 as a correction value.

Further, the curve line C12 shows that a correction resistance lower than that of the curve line C3 is added to the wirings 107_33 to 107_36 of Group 3 (wiring numbers 29 to 32 shown in FIG. 10) in the boundary region A1. That is, the curve line C12 shows that an intermediate value of the combined resistance value of the resistor 46R1 and the resistor 46R2 set to the CR circuit 46 and the resistance value of the resistor 45R set to the CR circuit 45 is added to the wirings 107_33 to 107_36 of Group 3 as a correction value.

The curve line C12 shows that a correction resistance lower than that of the curve line C3 is added to the wirings 107_92 to 107_96 of Group 3 (wiring numbers 28 to 36 shown in FIG. 10) in the boundary region A2. That is, the curve line C12 shows that an intermediate value of the combined resistance value of the resistor 46R1 and the resistor 46R2 set to the CR circuit 46 and the resistance value of the resistor 45R set to the CR circuit 45 is added to the wirings 107_92 to 107_96 of Group 3 (wiring numbers 28 to 32) as a correction value.

Further, the curve C12 shows that a correction resistance higher than that of the curve C2b is added to the wirings 107_97 to 107_100 of Group 2 (wiring numbers 33 to 36 shown in FIG. 10) in the boundary region A2. That is, the curve line C12 shows that an intermediate value of the resistance value of the resistor 45R set to the CR circuit 45 and the combined resistance value of the resistor 46R1 and the resistor 46R2 set to the CR circuit 46 is added to the wirings 107_97 to 107_100 of Group 2 as a correction value.

The curve line C12 shows that a correction resistance lower than that of the curve C2b is added to the wirings 107_113 to 107_116 of Group 2 (wiring numbers 49 to 52 shown in FIG. 10) in the boundary region B2 (wirings numbers 49 to 57 shown in FIG. 10). That is, the curve line C12 shows that an intermediate value of the resistance value of the resistor 45R set to the CR circuit 45 and 0Ω is added to the wirings 107_113 to 107_116 of Group 2 as a correction value.

Further, the curve line C12 shows that a correction resistance higher than that of the curve line C21 is added to the wirings 107_117 to 107_121 of Group 1 (wiring numbers 53 to 57 shown in FIG. 10) in the boundary region B2. That is, the curve line C12 shows that an intermediate value of 0Ω and the resistance value of the resistor 45R set to the CR circuit 45 is added to the wirings 107_117 to 107_121 of Group 1 as a correction value.

As explained above, in the output circuits (e.g., output circuits 26_8 to 26_12) within a predetermined boundary preliminarily set from each boundary of the plurality of divided regions, between two resistances (resistance of the CR circuit 44 and resistance of the CR circuit 45) set corresponding to each of adjacent regions across the boundary among divided regions, the resistance (resistance of the CR circuit 44) set corresponding to the region belonging to itself and the resistance (resistance of the CR circuit 45) set corresponding to the adjacent region are alternately selected every one frame display of a liquid crystal panel. That is, in each boundary region, switching the CR circuit of the adjustment circuit 40 every one frame makes the switching of the correction resistance value in the boundary region hard to see in the display of the liquid crystal display, and therefore, the display quality can be further improved.

One hundred twenty-eight (128) corrected resistance values shown by the curve line C1a, the curve line C1b, the curve line C2a, the curve line C2b, and the curve line C3 and one hundred twenty-eight (128) resistance values shown by curve line C12 were compared. That is, with respect to each of 128 resistance values, in the same manner as in Embodiment 1, the average AVG, the minimum value MIN, the maximum value MAX, the difference (MAX−MIN), and the variance σ² were obtained, and compared. The comparison results are as follows:

As explained in Embodiment 1, the average ACG, the minimum value MIN, the maximum value MAX, the difference (MAX-MIN), and the variance σ² of the 128 corrected resistance values shown by the curve line C1a, the curve line C1b, the curve line C2a, the curve line C2b, and the curve line C3 were 0.986, 0.839, 1.175, 0.336, and 0.0079. On the other hand, the average ACG, the minimum value MIN, the maximum value MAX, the difference (MAX−MIN), and the variance σ² of the 128 resistance values shown by the curve line C12 were 0.988, 0.888, 1.122, 0.233, and 0.0035.

It is understood that the variance σ² and the difference (MAX−MIN) are decreased by providing the adjustment circuit 40 to alternately add a correction resistance to the wirings 107 every one frame.

From this, by providing the adjustment circuit 40 to add a correction resistance to the wirings 107 in the boundary region every one frame, in the same manner as in Embodiment 1, the difference of the wiring resistance among the wirings 107 between the output circuit 26_{—}i and the gate line can be reduced, and further, the difference of the wiring resistances in the boundary region can be reduced. Furthermore, since the wiring resistance difference can be reduced, the potential difference of the scanning signal voltage Vg at the inlet (connecting point of the wiring 107) of the gate line every gate line can be eliminated, which in turn can improve the display quality of the liquid crystal display device 1. Moreover, the display quality in the boundary region can be improved.

In addition, the ratio of the correction resistance to be used can be changed without uniformly switching the correction value in the boundary region by 50% (i.e., every one frame) as mentioned above.

For example, in a plurality of frames, as it approaches the opposed Group in the boundary region, by reducing the selection ratio of the CR circuit provided corresponding to the Group to which the CR circuit belongs and on the other hand by increasing the selection ratio of the CR circuit provided corresponding to the adjacent Group, the display in the boundary region can be more smooth.

As one example, in the adjustment circuit 40 of the output circuits 26_8 to 26_12 connected to each of the wirings 107_8 to 107_12 of the wirings 107 of Group 1 among the wirings 107 in the boundary region B1, the selection ratio of the CR circuit 44 and the CR circuit 45 is changed to 9:1, 8:2, 7:3, 6:4, and 5:5.

In the adjustment circuit 40 of the output circuits 26_13 to 26_16 connected to each of the wirings 107_13 to 107_16 of Group 2 among the wirings 107 in the boundary region B1, the selection ratio of the CR circuit 44 and the CR circuit 45 is changed to 4:6, 3:7, 2:8, and 1:9.

In the adjustment circuit 40 of the output circuits 26_28 to 26_32 connected to each of the wirings 107_28 to 107_32 of Group 2 among the wirings 107 in the boundary region A1, the selection ratio of the CR circuit 45 and the CR circuit 46 is changed to 9:1, 8:2, 7:3, 6:4, and 5:5.

In the adjustment circuit 40 of the output circuits 26_33 to 26_36 connected to each of the wirings 107_33 to 107_36 of Group 3 among the wirings 107 in the boundary region A1, the selection ratio of the CR circuit 45 and the CR circuit 46 is changed to 4:6, 3:7, 2:8, and 1:9.

In the adjustment circuit 40 of the output circuits 26_92 to 26_96 connected to each of the wirings 107_92 to 107_96 of Group 3 among the wirings 107 in the boundary region A2, the selection ratio of the CR circuit 46 and the CR circuit 45 is changed to 9:1, 8:2, 7:3, 6:4, and 5:5.

In the adjustment circuit 40 of the output circuits 26_97 to 26_100 connected to each of the wirings 107_97 to 107_100 of Group 2 among the wirings 107 in the boundary region A2, the selection ratio of the CR circuit 46 and the CR circuit 45 is changed to 4:6, 3:7, 2:8, and 1:9.

In the adjustment circuit 40 of the output circuits 26_113 to 26_116 connected to each of the wirings 107_113 to 107_116 of Group 2 among the wirings 107 in the boundary region B2, the selection ratio of the CR circuit 45 and the CR circuit 44 is changed to 9:1, 8:2, 7:3, and 6:4.

Further, in the adjustment circuit 40 of the output circuits 26_117 to 26_121 connected to each of the wirings 107_117 to 107_121 of Group 1 among the wirings 107 in the boundary region B2, the selection ratio of the CR circuit 45 and the CR circuit 44 is changed to 5:5, 4:6, 3:7, 2:8, and 1:9.

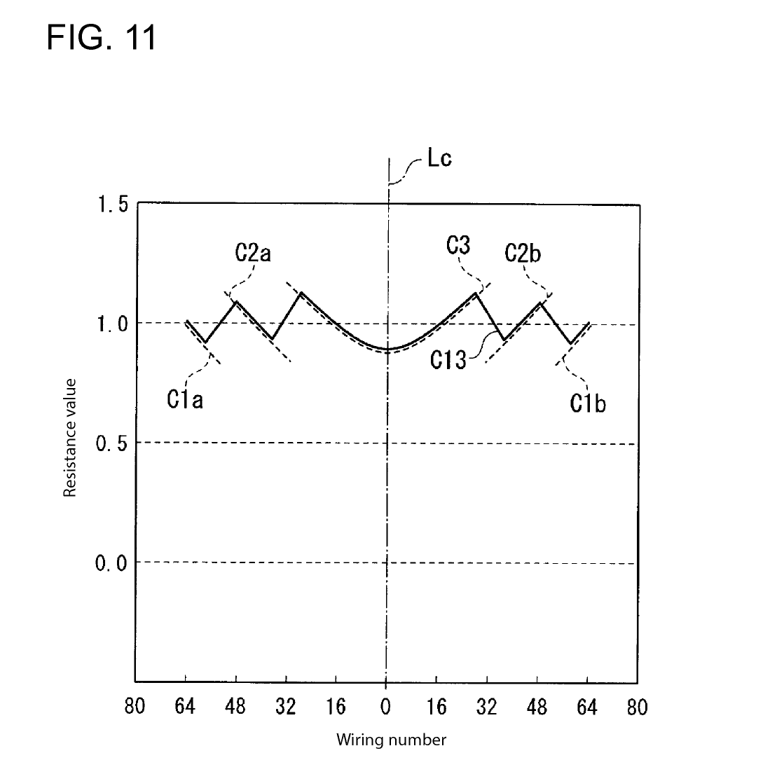

FIG. 11 is a diagram showing corrected resistance values in the case in which a selection ratio of the correction resistance to be added to the wiring resistance of the wiring 107 in a boundary region is changed. In FIG. 11, the curve line C1a, the curve line C1b, the curve line C2a, the curve line C2b, and the curve line C3 shown in FIG. 7 are also shown.

In FIG. 11, the curve line C13 shows corrected pseudo-resistance values of the wiring 107_{—}i in the case in which a selection ratio of a correction resistance to be added to the wiring resistance of the wiring 107 in a boundary region is changed. That is, the curve line C13 shows a pseudo-inclination tendency (variation of wiring resistance corresponding to the array direction of the wirings 107) of the wirings 107 in the case in which a selectin ratio of a correction resistance to be added to the wiring resistance of the wiring 107 is changed.

The curve line C12 shows that the correction resistance changes gradually as compared with the curve line C1a, the curve line C1b, the curve line C2a, the curve line C2b, and the curve line C3, in the boundary region.

In this manner, in each boundary region, switching the CR circuit of the adjustment circuit 40 by changing the selection ratio makes the switching of the correction resistance value in the boundary region hard to see in the display of the liquid crystal display, which further improves the display quality.

One hundred twenty-eight (128) corrected resistance values shown by the curve line C1a, the curve line C1b, the curve line C2a, the curve line C2b, and the curve line C3 and one hundred twenty-eight (128) resistance values shown by the curve C13 are compared. That is, with respect to each of 128 resistance values, in the same manner as in Embodiment 1, the average AVG, the minimum value MIN, the maximum value MAX, the difference (MAX−MIN), and the variance σ² were obtained, and compared. The comparison results are as follows:

As explained in Embodiment 1, the average ACG, the minimum value MIN, the maximum value MAX, the difference (MAX−MIN), and the variance σ² of the 128 corrected resistance values shown by the curve line C1a, the curve line C1b, the curve line C2a, the curve line C2b, and the curve line C3 were 0.986, 0.839, 1.175, 0.336, and 0.0079. On the other hand, the average ACG, the minimum value MIN, the maximum value MAX, the difference (MAX−MIN), and the variance σ² of the 128 resistance values shown by the curve line C13 were 0.988, 0.888, 1.122, 0.233, and 0.0037.

It is understood that the variance α² and the difference (MAX−MIN) are decreased by providing the adjustment circuit 40 to add a correction resistance to the wirings 107 in the boundary region by changing a selection ratio.

As explained above, in the display of a plurality of frames of a liquid crystal panel, in the output circuits (e.g., output circuits 26_8 to 26_12) within a predetermined boundary preliminarily set from each boundary of the divided plurality of regions, between two resistances (resistance of the CR circuit 44 and resistance of the CR circuit 45) set corresponding to each of adjacent regions across the boundary among divided regions, the selection ratio that the resistance (resistance of the CR circuit 44) to be set corresponding to the region that it belongs is selected decreases as it approaches the boundary. On the other hand, the ratio that resistance (resistance of the CR circuit 45) to be set corresponding to the adjacent region increases is selected as it approaches the boundary. That is, by providing the adjustment circuit 40 to add a correction resistance to the wirings 107 in the boundary region by changing the selection ratio, in the same manner as in Embodiment 1, the difference of the wiring resistance among the wirings 107 between the output circuit 26_{—}i and the gate line can be reduced, and further, the variation of the wiring resistances in the boundary region can be reduced. Furthermore, since the wiring resistance difference can be reduced and the variation can be reduced smoothly, the potential difference of the scanning signal voltage Vg at the inlet (connecting point of the wiring 107) of the gate line every gate line can be eliminated to reduce the potential difference, which in turn can improve the display quality of the liquid crystal display device 1, especially the display quality at the boundary region.

Although the embodiments of the present invention have been detailed with reference to the drawings, the concrete structure is not limited to these embodiments, and includes designs, etc., within a range which does not deviate the gist of the present invention.

For example, the material of the resistance of the CR circuit in the output circuit 26_{—}i can be the same material as the wiring 107, e.g., aluminum, or the like, and also can be polysilicon, or the like, different from the wiring 107. The material of the resistance can be matched to the material used for the source driver IC 25 or the gate driver IC 26. Further, the configuration of the resistance can be a linear configuration or a bent configuration, and can be matched to the configuration normally used source driver IC 25 or the gate driver IC 26.

Further, the prior art document describes an example in which a resistance is added to each of the lead-out wiring (wiring 106 in this application) on the integrated circuit side. However, in the present application, since the wiring is selected by the CR circuit, it is not required to prepare a resistance having a resistance value corresponding to the resistance value of the wiring 107 corresponding to each wiring 106. Therefore, the types of the resistance provided at the integrated circuit (source driver IC 25 or gate driver IC 26) side can be reduced, and can be selected as mentioned above.

Further, examples in which the present invention is applied to the gate driver IC 26 in Embodiment 1 and applied to the source driver IC 25 in Embodiment 2 are described. However, the present invention can be applied to both the gate driver IC 26 and the source driver IC 25.

Further, in Embodiment 3, the description was directed to the gate driver IC, however, the contents can also be applied to the source driver IC shown in FIG. 1. That is, switching the CR circuits every frame or every plurality of frames or switching the CR circuits by changing the selection ratio in a plurality of frames can be applied to a source driver IC.

Needless to say, the gradation signal voltage in the description of each of the aforementioned embodiments is included not only in the case of monochrome but also in the case of color.

Further, the description of each of the aforementioned embodiments was made as an example of a liquid crystal display device, but the present invention can be generally applied to a display device such as an organic EL (electro-Luminescence) display device, or the like.

### INDUSTRIAL APPLICABILITY

The present invention can be preferably applied to a display drive apparatus and a display device.

### DESCRIPTION OF REFERENCE CHARACTERS

1l liquid crystal display device
11 TFT substrate
12 opposite substrate
13 liquid crystal layer
14, 18 glass substrate
15 color filter layer
16 sealing member
24 SOF
25 source driver IC
15 gate driver IC
26_{—}i output circuit
31 display region
32 non-display region
40 adjustment circuit
41 gate driver
42 demultiplexer
43 multiplexer
44, 45, 46 CR circuit
45R, 46R1, 46R2 resistor
45C, 46C1, 46C2, Cs, CLCD capacitance
51 TFT
52 pixel electrode
53 opposite electrode
54, 55 electrode
104, 105, 106, 107 wiring
109 wiring substrate
110 flexible substrate
200 control device
200a controlling IC

1. A display driver having a plurality of output terminals, a pitch of which is smaller than a pitch of pixels of a liquid crystal panel to which the display driver is configured to be connected, the display driver comprising:
a plurality of output circuits each including a driver output segment, each output circuit being configured to connect the driver output segment therein to one of a plurality of lead-out wiring lines disposed on the liquid crystal panel, the plurality of lead out wiring lines being respectively connected, at another end thereof, to a plurality of gate lines or a plurality of signal lines on the liquid crystal panel, the plurality of gate lines and the plurality of the signal lines together forming a matrix structure of the liquid crystal panel,
wherein each of the output circuits further include an adjustment circuit between the driver output segment and the lead-out wiring line for offsetting a variation in wiring resistance among a plurality of the lead-out wiring lines.

2. The display driver according to claim 1, wherein each adjustment circuit includes: a resistance circuit having a plurality of selectable resistors, the resistance values of the plurality of resistors being set according to the variation in wiring resistance among the plurality of the lead-out wiring lines; and a selection circuit that selects one of the plurality of resistors in the resistance circuit to electrically connect the driver output segment in the output circuit to the corresponding lead-out wiring line.

3. The display driver according to claim 2,
wherein each selection circuit selects the same one of the plurality of resistors every frame of display,
wherein the plurality of output circuits are grouped into a plurality of groups depending on a distance from the output circuit that is located at a center, and one of the plurality of resistors is assigned to each group depending on said distance, and
wherein in each resistance circuit of each output circuit, the one of the plurality assigned to the group to which the output circuit belongs is selected.

4. The display driver according to claim 2, further comprising:
a controlling device that outputs selection signals to the selection circuits such that:
two or more resistors among the plurality of resistors in the resistance circuit are selected over a plurality of frames of display, depending on a distance from the output circuit that is located at a center.

5. The display driver according to claim 4,
wherein the plurality of output circuits are grouped into a plurality of groups depending on said distance from the output circuit that is located at the center, and one of the plurality of resistors is assigned to each group, and
wherein in each of the output circuits that are located in a boundary region defined adjacent to a boundary dividing the adjacent groups, the assigned resistor and another resistor assigned to the adjacent group are alternately selected every frame of display.

6. The display driver according to claim 4,
wherein the plurality of output circuits are grouped into a plurality of groups depending on said distance from the output circuit that is located at the center, and one of the plurality of resistors is assigned to each group, and
wherein in each of the output circuits that are located in a boundary region defined adjacent to a boundary dividing the adjacent groups, the closer the output circuit is with respect to the boundary, the smaller a frequency at which the assigned resistor is selected and the greater a frequency at which another resistor assigned to the adjacent divided region is selected.

7. A display device, comprising said liquid crystal panel and the display driver according to claim 1 mounted on said liquid crystal panel.
